(19) United States
(12) Patent Application Publication
(10) Pub. No.: US 2015/0085473 A1
(43) Pub. Date: Mar. 26, 2015

(54) LED Backlight Display Device and LED Backlight Arrangement Method

(71) Applicant: Tsuneo Miyamoto, Tokyo (JP)

(72) Inventor: Tsuneo Miyamoto, Tokyo (JP)

(73) Assignee: NEC Display Solutions, Ltd.

(21) Appl. No.: 14/402,836

(22) PCT Filed: May 28, 2012
(86) PCT No.: PCT/JP2012/063625

§ 371 Date: Nov. 21, 2014

(51) Int. Cl. G02F 1/1335; F21K 99/00

(52) U.S. Cl. CPC G02F 1/133603; F21K 9/00; G02F 1/133611
USPC 362/97.3

(57) ABSTRACT

An LED backlight display device has a display panel body having a substantially rectangular shape which includes longer sides and shorter sides as edge portions; and a backlight arranged in a manner such that LED light emitting elements are aligned along the edge portions of the display panel body. The backlight is arranged at any one of the longer sides and the shorter sides of the display panel body; and a front sensor that measures luminance and chromaticity of the backlight is arranged at one side among the longer sides and the shorter sides of the display panel body where the backlight is not arranged at the one side.

### TECHNICAL FIELD

The present invention relates to an LED backlight display device and an LED backlight arrangement method, which are applied to a light source such as a liquid crystal panel, and pertains to a technique which makes it possible to measure luminance and chromaticity utilizing a front sensor that is not affected by temporal change of LEDs.

### BACKGROUND ART

Most conventional liquid crystal monitors or the like employ a backlight utilizing a CCFL (Cold Cathode Fluorescent Lamp). Therefore, even though a front sensor is arranged in the vicinity of the CCFL in an edge-type backlight, a phenomenon in which the luminance and chromaticity varies in only part of the CCFL does not occur, and thus the display condition of the entire display screen does not change.

However, in recent years, an LED backlight is watched with interest as a backlight (light emitting device) which irradiates a light modulating element (e.g., a liquid crystal panel) from the back of the element.

For example, Patent Document 1 discloses LED backlights which emit irradiation light of white light by arranging white LEDs or emit white light by arranging LEDs of three colors that are R (red), G (green), and B (blue) mixed together.

The LED backlight is arranged on the longer sides (lengths) of the body of a liquid crystal panel and controls the luminance and chromaticity of the screen based on a measurement signal sent from a front sensor.

More specifically, in an ordinary display device 1 shown in FIGS. 4 and 5, an LED backlight 3 is arranged on each longer side 2A of an liquid crystal panel body 2 which generally has a rectangular shape that includes the longer sides 2A and shorter sides 2B (widths).

The LED backlight 3 has a plurality of light emitting elements 3A aligned vertically along the longer sides 2A of the liquid crystal panel body 2 and a front sensor S1 is provided at the LED light emitting elements 3A.

Similar to the LED backlight 3, the front sensor S1 is arranged on the longer sides 2A of the liquid crystal panel body 2. The front sensor S1 measures the luminance and chromaticity of the LED light emitting elements 12A so as to control the luminance and chromaticity of the relevant screen.

Generally, at the time of shipping the products, the luminance and chromaticity measured utilizing the front sensor S1 do not always coincide with the luminance and chromaticity shown at a central part A of the screen, due to a variation in the screen or the like. Therefore, a factory worker or the like calibrates the screen in advance so that the measured values of the front sensor S1 coincide with the luminance and chromaticity at the central part A of the screen.

Additionally, in most ordinary edge-type backlights utilizing a CCFL (Cold Cathode Fluorescent Lamp), a front sensor S1 is also arranged on the longer sides of the body, as shown in FIG. 5, so as to attach the front sensor S1 at a relatively inconspicuous position.

### PRIOR ART DOCUMENT

### Patent Document

Patent Document 1: Japanese Unexamined Patent Application, First Publication No. 2010-91816.

### DISCLOSURE OF INVENTION

### Problem to be Solved by the Invention

As described above, the LED backlight 3 is arranged on the longer sides of the liquid crystal panel body 2. When the front sensor S1 is also arranged at the longer sides, the front sensor S1 strongly correlates with the LED light emitting elements 3A (specifically, LED light emitting elements 3A indicated by “LED_R1” to “LED_R3” in FIG. 5) in the vicinity of the front sensor S1.

More specifically, in a light source such as the LED backlight 3 formed by a plurality of small light sources, the LED light emitting elements 3A in the vicinity of the front sensor S1 (i.e., those indicated by LED_R1 to LED_R3 in FIG. 5) considerably affects the measurement of the luminance and chromaticity utilizing the front sensor S1. Therefore, if performing the screen control based on the measured values of the front sensor S1 in an abnormal state of the LED light emitting elements 3A in the vicinity of the front sensor S1, the screen may not be accurately controlled.

That is, when a dispersion due to a temporal change occurs between the individual LED light emitting elements 3A, even though controlling the screen based on the measured values of the front sensor S1, a variation occurs, in particular, in the luminance and chromaticity of the central part A of the screen due to the LED light emitting elements 3A having such a dispersion.

In light of the above circumstances, an object of the present invention is to provide an LED backlight display device and an LED backlight arrangement method, which remove an effect such as a dispersion due to a temporal change that occurs at the individual LED light emitting elements so as to reduce the relevant influence on the measurement of the luminance and chromaticity utilizing a front sensor to a minimum degree.

### Means for Solving the Problem

In order to achieve the above object, the present invention provides an LED backlight display device comprising:

a display panel body having a substantially rectangular shape which includes longer sides and shorter sides as edge portions; and

a backlight arranged in a manner such that LED light emitting elements are aligned along the edge portions of the display panel body,

wherein the backlight is arranged at any one of the longer sides and the shorter sides of the display panel body; and

a front sensor that measures luminance and chromaticity of the backlight is arranged at one side among the longer sides and the shorter sides of the display panel body where the backlight is not arranged at said one side.

The present invention also provides an LED backlight arrangement method comprising:

providing a display panel body having a substantially rectangular shape which includes longer sides and shorter sides as edge portions, and a backlight arranged in a manner such that LED light emitting elements are aligned along the edge portions of the display panel body;

arranging the backlight at any one of the longer sides and the shorter sides of the display panel body; and

arranging a front sensor that measures luminance and chromaticity of the backlight at one side among the longer sides and the shorter sides of the display panel body where the backlight is not arranged at said one side.

### Effect of the Invention

In accordance with the present invention, the backlight is arranged at any one of the longer sides and the shorter sides of the display panel body, and a front sensor that measures luminance and chromaticity of the backlight is arranged at one side among the longer sides and the shorter sides where the backlight is not arranged at said one side. Therefore, the front sensor is positioned away from the LED light emitting elements which form the LED backlight by a specific distance or greater.

Accordingly, there is no considerable difference between the quantities of light received from the individual LED light emitting elements to the front sensor. Even if one of the LED light emitting elements has a variation in the light emission efficiency due to temporal and temperature changes thereof and the luminance and chromaticity of this LED light emitting elements varies, no considerable variation occurs in the measured values of the front sensor. As a result, regarding the light measurement utilizing the front sensor, it is possible to remove the influence for a dispersion due to a temporal change or the like between the individual LED light emitting elements, and thereby the luminance and chromaticity measurement utilizing the front sensor can be stably performed.

### BRIEF DESCRIPTION OF THE DRAWINGS

FIG. 1 is a front view that shows an appearance of an LED backlight display device 10 according to an embodiment of the present invention.

FIG. 2 is a front view that shows an arrangement of LED light emitting elements 12A, which form in a backlight 12, and a front sensor S2 in the LED backlight display device 10 of FIG. 1.

FIG. 3 is a front view that shows a state in which light emitted from the LED light emitting elements 12A is received by the front sensor S2 in the LED backlight display device 10 of FIG. 2.

FIG. 4 is a front view that shows an appearance of a conventional LED backlight display device 1.

FIG. 5 is a front view that shows an arrangement of LED light emitting elements 3A, which form a backlight 3, and a front sensor S1 in the LED backlight display device 1 of FIG. 5.

### MODE FOR CARRYING OUT THE INVENTION

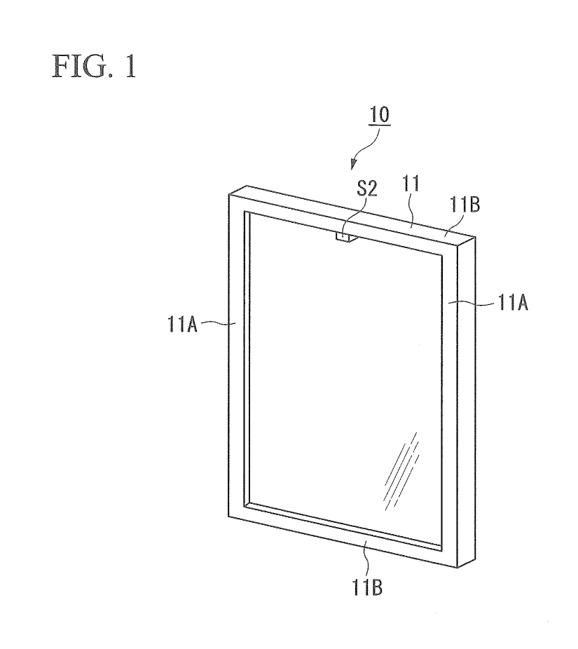

Below, an embodiment of the present invention will be explained with reference to FIGS. 1 to 3. The embodiment explained below is an example of embodiments of the present invention and the present invention is not limited to the present embodiment.

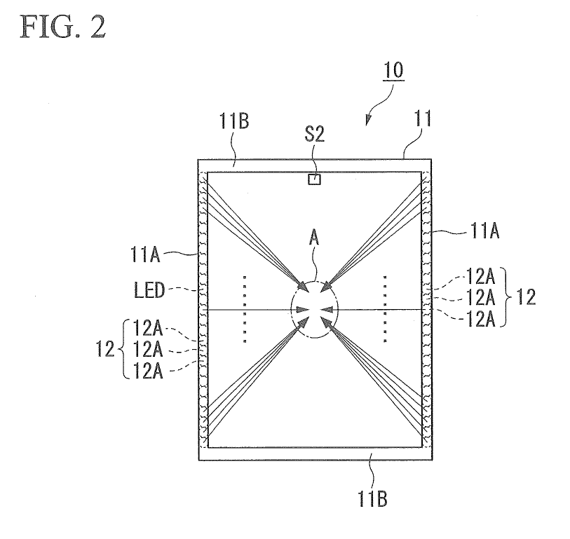

FIGS. 1 and 2 show an LED backlight display device 10 according to the present invention, in which an LED backlight 12 is arranged on each longer side 11A of an liquid crystal panel body 11 that generally has a rectangular shape and has a frame consisting of the longer sides 11A (lengths) and shorter sides 11B (widths). The LED backlight 12 has a plurality of LED light emitting elements 12A aligned along the longer sides 11A of the liquid crystal panel body 11.

In addition, a front sensor S2 is provided at a shorter side 11B. Specifically, the front sensor S2 is arranged at the center of the shorter side 11B of the liquid crystal panel body 11. Based on measurement signals output from the front sensor S2, the luminance and chromaticity of the entire LED backlight 12 are controlled.

Generally, at the time of shipping the products, the luminance and chromaticity measured utilizing the front sensor S2 do not always coincide with the luminance and chromaticity shown at a central part A of the screen, due to a variation in the screen or the like. Therefore, a factory worker or the like performs a calibration in advance so that the measured values of the front sensor S2 indicate the luminance and chromaticity at the central part A of the screen.

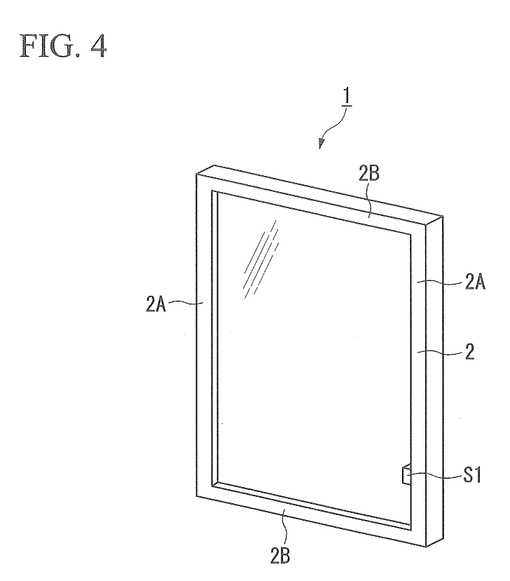

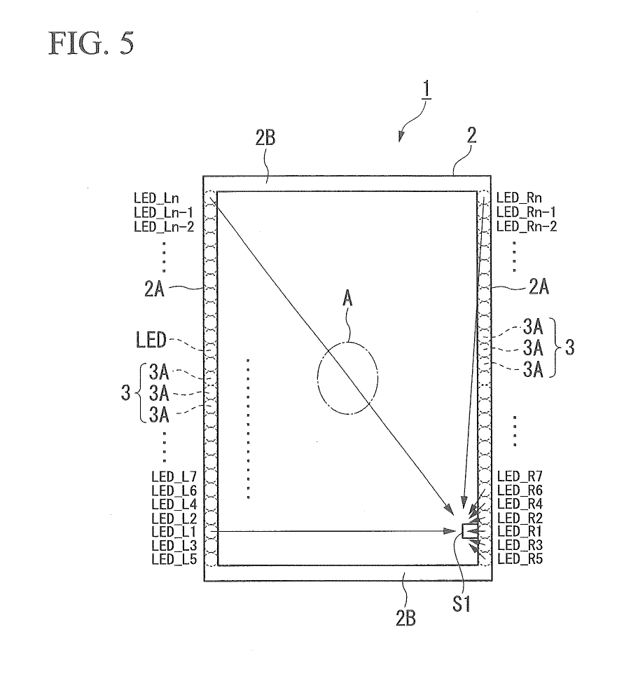

In a display device having a structure in which a plurality of edge-type and LED backlight type light sources are discretely arranged, as shown in FIGS. 4 and 5, LED light emitting elements 3A that functions as a light source are generally arranged at longer sides of the relevant body. In such a case, the front sensor S1 is most strongly affected by the luminance and chromaticity of the nearest one or two LED light emitting elements 3A (specifically, see the LED light emitting elements 3A indicated by “LED_R1” to “LED_R3” in FIG. 5), and influence by the distant LED light emitting elements 3A is extremely weak. When only the light emission efficiency of the strongly affecting LED light emitting elements 3A varies due to a dispersion in the light emission efficiency typically caused by a temporal change and a temperature change, the luminance and chromaticity of the central part A of the screen, which were calibrated utilizing the values of the front sensor, may be deviated from accurate values.

Therefore, in the present embodiment, as shown in FIG. 2, the front sensor S2 is arranged at a shorter side 11B (of the liquid crystal panel body 11) along which no light emitting elements 12A are arranged.

That is, the front sensor S2 is arranged at the center of the shorter side 11B of the liquid crystal panel body 11, such position being distant from the longer sides 11A (of the liquid crystal panel body 11) where the LED light emitting elements 12A are arranged. Therefore, the front sensor S2 is distant from the individual light emitting elements 12A by a specific distance or greater, by which influence for a dispersion in the light emission efficiency due to temporal and temperature changes of the LED light emitting elements 12A is disregarded or averaged.

Accordingly, values measured by the front sensor S2 make it possible to disregard the influence for a dispersion in the light emission efficiency due to the temporal and temperature changes of the individual LED light emitting elements 12A. Therefore, it is possible to prevent bad influence by the control of the backlight 12 based on the measurement values of the front sensor S2, on the luminance and chromaticity of the central part A of the screen.

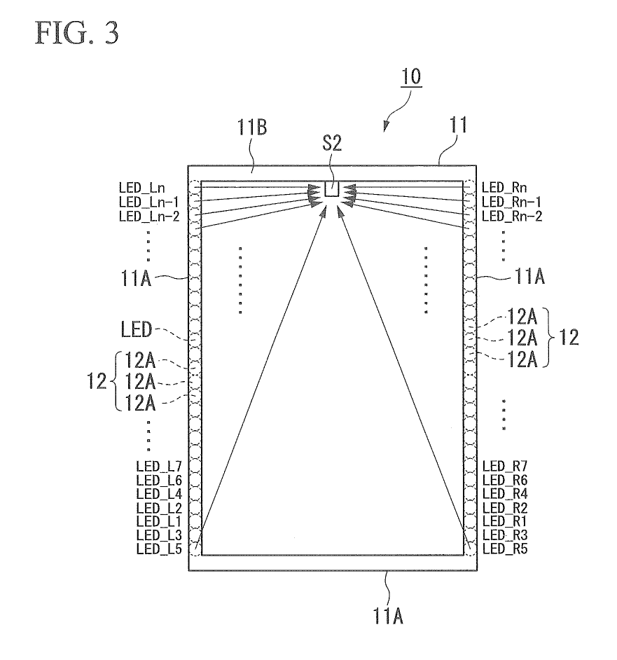

The above function will be specifically explained with reference to FIGS. 2 and 3. First, as shown in FIG. 2 pertaining to the present invention, regarding the quantity of light received by the central part A of the screen, the quantity of light from the LED light emitting elements 12A arranged at a central portion of each longer side 11A of the liquid crystal panel body 11 is greatest while the quantity of light from the LED light emitting elements 12A arranged at both end portions of each longer side 11A of the liquid crystal panel body 11 is smallest.

However, the individual LED light emitting elements 12A are distant from the central part A of the screen. Therefore, even if one LED light emitting element 12A has varied in a manner different from those of the other LED light emitting elements 12A, typically due to a dispersion in the light emission efficiency caused by a temporal change and a temperature change, the influence on the luminance and chromaticity of the central part A of the screen is very small and thus can be disregarded.

FIG. 5 shows the position of the front sensor S1 pertaining to the conventional technique. The luminance and chromaticity measured by the front sensor S1 does not always coincide with the luminance and chromaticity represented at the central part A of the screen, due to a variation in the screen or the like. Therefore, it is necessary to perform a calibration in advance so that the measured values of the front sensor S1 indicate the luminance and chromaticity at the central part A of the screen. The quantity of light received by the front sensor S1 in FIG. 5 is greatly affected by LED light emitting elements 3A in the vicinity of the sensor (specifically, the LED light emitting element 3A indicated by “LED_R1” in FIG. 5), and thus it can be said that the luminance and chromaticity of the central part A of the screen is determined almost by the LED light emitting element 3A indicated by LED_R1. Therefore, if only the LED light emitting element 3A indicated by LED_R1 has a failure in the measurement due to a dispersion in the light emission efficiency typically caused by a temporal change and a temperature change, the luminance and chromaticity of the central part A of the screen cannot be accurately controlled.

In contrast, in the display device 10 according to the embodiment of the present invention, as shown in FIG. 3, the front sensor S2 is arranged at the center of the shorter side 11B of the liquid crystal panel body 11, and thus the longer the distance between the front sensor S2 and each LED light emitting element 12A, the smaller the quantity of light received by the front sensor S2 from the element (see the LED light emitting elements 12A indicated by Rn, Rn-1, Rn-2, . . . or Ln, Ln-1, Ln-2, . . . ). Additionally, the front sensor S2 is distant from the plurality of the LED light emitting elements 12A by a specific distance or greater. Therefore, even if only one of the LED light emitting elements 12A has a failure in the measurement due to a dispersion in the light emission efficiency typically caused by a temporal change and a temperature change, the relevant influence on the front sensor S2 is remarkably small in comparison with the case shown in FIG. 5. Accordingly, it is possible to reduce the influence on the luminance and chromaticity of the central part A of the screen, which are controlled based on the measured values of the front sensor S2, to a minimum degree.

As described above in detail, in accordance with the LED backlight display device 10 and the LED backlight arrangement method of the present embodiment, the LED backlight 12 is arranged at the pair of the longer sides 11A of the liquid crystal panel body 11 while the front sensor S2 utilized to measure the luminance and chromaticity of the LED backlight 12 is arranged at the center of a shorter side 11B of the liquid crystal panel body 11, at which no LED backlight 12 is arranged. Therefore, the front sensor S2 is positioned away from the LED light emitting elements 12A which form the LED backlight 12 by a specific distance or greater.

Therefore, there is no considerable difference between the quantities of light received from the individual LED light emitting elements 12A to the front sensor S2. Even if one of the LED light emitting elements 12A has a variation in the light emission efficiency due to temporal and temperature changes thereof and the luminance and chromaticity of this LED light emitting elements 12A varies, no considerable variation occurs in the measured values of the front sensor S2. As a result, regarding the light measurement utilizing the front sensor S2, it is possible to remove the influence for a dispersion due to a temporal change or the like between the individual LED light emitting elements 12A, and thereby the luminance and chromaticity measurement utilizing the front sensor S2 can be stably performed.

Therefore, in accordance with the LED backlight display device 10 and the LED backlight arrangement method of the present embodiment, even if a dispersion in the light emission efficiency typically caused by a temporal change or a temperature change in the individual LED light emitting elements 12A occurs, the relevant influence on the front sensor S2 can be reduced to a minimum degree. Therefore, it is possible to perform stable luminance and chromaticity control of the screen based on the measured values of the front sensor S2.

In the above embodiment, the LED backlight 12 is arranged at the pair of the longer sides 11A of the liquid crystal panel body 11 while the front sensor S2 utilized to measure the luminance and chromaticity of the LED backlight 12 is arranged at the center of a shorter side 11B of the liquid crystal panel body 11, at which no LED backlight 12 is arranged. However, the positional relationship between the LED backlight 12 and the front sensor S2 may be reversed. That is, the LED backlight 12 may be arranged at the shorter sides 11B of the liquid crystal panel body 11 while the front sensor S2 may be arranged at the longer sides 11A of the liquid crystal panel body 11. Also in this case, similar to the above embodiment, influence of a dispersion in the light emission efficiency between the individual LED light emitting elements 12A on the front sensor S2 can be reduced to a minimum degree.

That is, since the present invention is not limited to the above embodiment, the LED light emitting elements 12A of the LED backlight 12 may be arranged at the shorter sides 11B of the liquid crystal panel body 11 while the front sensor S2 may be arranged at the center of one of the longer sides 11A of the liquid crystal panel body 11.

In another example, the LED light emitting elements 12A of the LED backlight 12 are arranged at only one of the longer sides 11A or the shorter sides 11B (i.e., only one of the four sides) while the front sensor S2 is arranged at any one of the three sides other than the side along which the LED light emitting elements 12A are arranged.

That is, the LED backlight 12 may be arranged at one of the longer sides 11A or the shorter sides 11B while the front sensor S2 utilized to measure the luminance and chromaticity of the LED backlight 12 may be arranged at a longer side 11A or a shorter side 11B at which no LED backlight 12 is arranged.

In addition, the position at which the front sensor S2 of the above embodiment is attached is not limited to that corresponding to the central part A of the screen and thus may be shifted from the central position toward either side thereof if the front sensor S2 is sufficiently distant from the LED light emitting elements 12A of the LED backlight 12. That is, the arrangement position can be appropriately modified according to existing circumstances.

The whole or part of the above-described embodiment can be described as, but not limited to, the following supplementary notes.

### Supplementary Note 1

An LED backlight display device comprising:

a display panel body having a substantially rectangular shape which includes longer sides and shorter sides as edge portions; and

a backlight arranged in a manner such that LED light emitting elements are aligned along the edge portions of the display panel body,

wherein the backlight is arranged at any one of the longer sides and the shorter sides of the display panel body; and

a front sensor that measures luminance and chromaticity of the backlight is arranged at one side among the longer sides and the shorter sides where the backlight is not arranged at said one side.

### Supplementary Note 2

The LED backlight display device in accordance with Supplementary note 1, wherein:

the backlight is arranged at both the longer sides of the display panel body; and

the front sensor is arranged at any shorter side of the display panel body.

### Supplementary Note 3

The LED backlight display device in accordance with Supplementary note 1, wherein:

the backlight is arranged at both the shorter sides of the display panel body; and

the front sensor is arranged at any longer side of the display panel body.

### Supplementary Note 4

The LED backlight display device in accordance with any one of Supplementary notes 1 to 3, wherein:

the backlight is arranged at a central part of any longer side or shorter side of the display panel body.

### Supplementary Note 5

An LED backlight arrangement method comprising:

providing a display panel body having a substantially rectangular shape which includes longer sides and shorter sides as edge portions, and a backlight arranged in a manner such that LED light emitting elements are aligned along the edge portions of the display panel body;

arranging the backlight at any one of the longer sides and the shorter sides of the display panel body; and

arranging a front sensor that measures luminance and chromaticity of the backlight at one side among the longer sides and the shorter sides where the backlight is not arranged at said one side.

While embodiments of the present invention have been explained in detail referring to the drawings, specific structures are not limited to the embodiments. Design modification or the like can be made without departing from the scope of the present invention.

### REFERENCE SYMBOLS

10 LED backlight display device
11 liquid crystal panel body (display panel body)
11A longer side
11B shorter side
12 backlight
12A LED light emitting element
S2 front sensor

1. An LED backlight display device comprising:
a display panel body having a substantially rectangular shape which includes longer sides and shorter sides as edge portions; and
a backlight arranged in a manner such that LED light emitting elements are aligned along the edge portions of the display panel body,
wherein the backlight is arranged at any one of the longer sides and the shorter sides of the display panel body; and
a front sensor that measures luminance and chromaticity of the backlight is arranged at one side among the longer sides and the shorter sides of the display panel body where the backlight is not arranged at said one side.

2. The LED backlight display device in accordance with claim 1, wherein:
the backlight is arranged at both the longer sides of the display panel body; and
the front sensor is arranged at any shorter side of the display panel body.

3. The LED backlight display device in accordance with claim 1, wherein:
the backlight is arranged at both the shorter sides of the display panel body; and
the front sensor is arranged at any longer side of the display panel body.

4. The LED backlight display device in accordance with claim 1, wherein:
the backlight is arranged at a central part of any longer side or shorter side of the display panel body.

5. An LED backlight arrangement method comprising:
providing a display panel body having a substantially rectangular shape which includes longer sides and shorter sides as edge portions, and a backlight arranged in a manner such that LED light emitting elements are aligned along the edge portions of the display panel body;
arranging the backlight at any one of the longer sides and the shorter sides of the display panel body; and
arranging a front sensor that measures luminance and chromaticity of the backlight at one side among the longer sides and the shorter sides of the display panel body where the backlight is not arranged at said one side.

6. The LED backlight display device in accordance with claim 2, wherein:
the backlight is arranged at a central part of any longer side or shorter side of the display panel body.

7. The LED backlight display device in accordance with claim 3, wherein:
the backlight is arranged at a central part of any longer side or shorter side of the display panel body.
